(19) United States
(12) Patent Application Publication
(10) Pub. No.: US 2012/0035011 A1
(43) Pub. Date: Feb. 9, 2012

(54) ELECTRO MECHANICAL BICYCLE DERAILLEUR ACTUATOR SYSTEM AND METHOD

(76) Inventors: Haim MENACHEM, Holon (IL); Guy PERETZ, Holon (IL)

(21) Appl. No.: 12/852,537

(22) Filed: Aug. 9, 2010

(51) Int. Cl. B62M 25/08; B23P 11/00; F16H 7/22

(52) U.S. Cl. 474/126; 474/122; 29/401.1

(57) ABSTRACT

An electro mechanical bicycle derailleur actuator system, retrofittable to a bicycle having gearing and at least one derailleur, the derailleur having a cable, the system comprising: at least one derailleur actuator module (DAM) connectable to the bicycle and to the cable; a cyclist interface module (CIM) connectable to the bicycle for cyclist interface with the system; and a control and power module (CPM) connectable to the bicycle serving to control and power the system, wherein the bicycle gearing is shiftable by the system without derailleur cable modification.

### FIELD AND BACKGROUND OF THE INVENTION

Embodiments of the current invention are related to the gearing and derailleur mechanism of a bicycle. More specifically, embodiments of the present invention are directed to an electro mechanical derailleur actuator system and method thereof.

Bicycles are a well-established means for self transportation and for commuting. Since their introduction in the 19th century, bicycles have been widely accepted. Today they number about one billion worldwide, twice as many as automobiles. Bicycles are the principal means of transportation in many regions of the world. They also provide a popular form of recreation and sport, and a means of daily commuting to and from work.

The advent of the bicycle has had a major impact on society, both in terms of culture and of advancing modern industrial methods. Several bicycle components have been adapted and have eventually played a key role in the development of the automobile. Examples include: ball bearings; pneumatic tires; chain-driven sprockets; spoke-tensioned wheels, etc.

Reference is presently made to FIG. 1, which is a schematic side view of a prior art bicycle 10 having a frame 12, and showing major typical components of the prior art bicycle. FIG. 1 is introduced to generally define terms used in the specification and claims which follow. Frame 12 includes: handlebars 14; a cross bar 16; seat tube 18; a down tube 20; a seat stay 21, and a chain stay 22—all as indicated in the figure. Front and rear wheels 24 and 26, respectively, are supported by the frame, as known in the art. Typically, prior art bicycle 10 travels with front and rear wheels touching the ground (not shown) defining the direction “down”, (ie. towards the ground) with the opposing direction defined as “up” (ie, away from the ground). The typical direction in which prior art bicycle advances is defined as “forward” with the opposing direction defined as “rear” or backward.

A drive chain 30 (otherwise known as simply “chain”) typically engages a chainring 32, which is driven by a crank arm 34, as known in the art). A secondary chainring 33 may be engaged by drive chain 30, as described hereinbelow. Some modern bicycles have more than one or two chainrings driven by the crank arm and the gear wheels are respectively engaged by the chain, as known in the art. Furthermore, although not shown in the figure, most modern bicycles have additional chainrings mounted on the axis of rear wheel 26. Finally the terms “sprocket” and “gear wheel” may be interchanged and are equivalent with “chainring”.

Chain 30 is displaced from chainring 32 to chainring 34 by the action of a front derailleur 35 as known in the art. Furthermore, chain 30 is displaced between/among the additional chainrings mounted on the axis (not shown in the figure) of rear wheel 26 by the action of a rear derailleur 36, also as known in the art. An important aspect of modern bicycles is the “gears” or “gearing”—terms used in the specification and claims which follow intended to mean the configuration of the bicycle's gear wheels. Chain 30 interacts with the gears in a controlled manner, as known in the art, to enable a cyclist to maintain an approximately fixed pedaling speed while affording the cyclist a mechanical advantage versus the speed of the bicycle wheels (ie the speed of the bicycle on the terrain) and the cyclist/rider load.

In the specification and claims which follow, the term “chaining” is intended to mean the controlled displacement of the chain from one gear wheel to another gear wheel, effecting “gear changing”, “gear shifting”, or “changing gears” on a bicycle. Chaining is typically accomplished by a biasing movement of a derailleur against the chain, to yield the controlled chain movement described hereinabove, as known in the art. The expression “cogset” is intended to mean in the specification and claims which follow a combination of chainrings, whether associated with the crank arm or the rear wheel, as known in the art. Therefore, it may be said that chaining is typically accomplished on a cogset with the aid of the derailleur.

Typically, gear shifting is accomplished by means of a handlebar or stay-mounted shifter (not shown in the figure) having a cable 38 (for front derailleur 34) and a cable 39 (for rear derailleur 36), which serve to transfer the pull movement of the shifter to the respective derailleurs to shift gears, as known in the art.

Prior art bicycle gear shifting involves no small amount of cyclist/rider attention, which can detract from the riding experience and can even pose a safety concern. Many producers have attempted to manufacture automatic or electrically assisted bicycle gear actuation systems, but only few have succeeded in partially addressing problems such as: integration; operation; size; reliability; performance; and weight—inter alia.

One example of such prior art is U.S. Pat. No. 5,266,065 by Restelli, whose disclosure is incorporated herein by reference. Restelli describes an automated bicycle transmission comprising an actuator for movement into predetermined positions of a sprocket change mechanism member moving to engage a chain for transmission of motion opposite a predetermined sprocket among a plurality of coaxial sprockets of different diameter. The actuator is controlled by an electronic control device to which is connected a plurality of sensors including a sensor for detection of bicycle speed, as sensor for longitudinal slope or inclination of the bicycle and optionally a sensor of stress transmitted by the cyclist to the pedals. Restelli's description focuses solely on the rear wheel/rear derailleur and he gives no details of the actuator mechanism employed.

Another example is U.S. Pat. No. 5,577,969 by Watarai, whose disclosure is incorporated herein by reference. A multispeed bicycle having a shifting apparatus operable by a single manual lever to actuate the front and rear derailleurs is described. The shifting apparatus includes two actuating mechanisms for actuating front and rear derailleurs, respectively, and a shift controller for controlling the actuating mechanisms.

A third example is that of Ichida et al. In US patent application publications no. US 2008/0132364, whose disclosure is incorporated herein by reference. Ichida describes an electric derailleur motor unit provided for a motorized derailleur assembly. The electric derailleur motor unit has a derailleur motor support, a derailleur motor, a drive train and an output shaft. The output shaft, inter alia, has an output gear engaged with a worm gear of the drive train shaft.

The prior art cited generally addresses derailleur motor units or similar assisted shifting mechanisms using a worm gear. In all cases, the devices described are integral, meaning the bicycle employing the described devices must be either manufactured integrally and/or must have serious modifications made to a conventional bicycle-derailleur configuration to allow the devices to function correctly. One serious modification noted includes: cutting; shortening; rerouting; lengthening, removing; and replacing of the existing derailleur cable or cables.

There is therefore a need for a reliable and simplified electro mechanical derailleur actuation system that can be readily retrofitted to existing conventional derailleur gear shifting configurations without cable modification.

### SUMMARY OF THE INVENTION

According to the teachings of the present invention there is provided an electro mechanical bicycle derailleur actuator system, retrofittable to a bicycle having gearing and at least one derailleur, the derailleur having a cable, the system comprising: at least one derailleur actuator module (DAM) connectable to the bicycle and to the cable; a cyclist interface module (CIM) connectable to the bicycle for cyclist interface with the system; and a control and power module (CPM) connectable to the bicycle serving to control and power the system, wherein the bicycle gearing is shiftable by the system without derailleur cable modification. Preferably, derailleur cable modification includes one chosen from the list including: cutting; shortening; rerouting; lengthening, removing; and replacing of the cable. Most preferably, the at least one DAM further comprises: a mounting connectable to a stay of the bicycle and having positional adjustment in two degrees of freedom and a cable displacement unit (CDU) connectable to the mounting and the cable, the CDU having positional adjustment in a third degree of freedom. Typically, the CDU includes a motor having an axis, the motor adapted to drive a lead screw on which a rider is configured and wherein the rider is attachable to the cable, the rider adaptable to displace the cable to effect gear changes. Most typically, the CDU further includes an encoder attachable to the axis, the encoder adapted to provide feedback regarding cable displacement by the rider.

Preferably, the CDU additionally includes means to: receive commands from the CPM; transfer information regarding cable displacement to the CPM; and receive power from the CPM. Most preferably, the CIM includes on board power and a means to transfer commands to the CPM including one chosen from the list including: wireless and wired. Typically, the CPM includes on-board power and wiring to transfer the power to the CDU and means to transfer commands to and receive information from the CDU. Typically, means to transfer commands and receive information to and receive information from the CDU includes one chosen from list including: wireless and wired. Most typically, the system is commandable to allow bicycle gear shifting not by the system.

According to the teachings of the present invention there is further provided a method of retrofitting an electro mechanical bicycle derailleur actuator system to a bicycle having gearing and at least one derailleur the derailleur having a cable, the method comprising the steps of: connecting at least one derailleur actuator module (DAM) to the bicycle and to the cable; connecting a cyclist interface module (CIM) to the bicycle for cyclist interface with the system; and connecting a power module (CPM) to the bicycle serving to control and power the system, wherein the bicycle gearing is shifted by the system without derailleur cable modification. Preferably, derailleur cable modification includes one chosen from the list including: cutting; shortening; rerouting; lengthening, removing; and replacing of the cable. Most preferably, the at least one DAM further comprises: a mounting connected to a stay of the bicycle and having positional adjustment in two degrees of freedom and a cable displacement unit (CDU) connected to the mounting and the cable, the CDU having positional adjustment in a third degree of freedom. Typically, the CDU includes a motor having an axis, the motor driving a lead screw on which a rider is configured and wherein the rider is attached to the cable, the rider displacing the cable to effect gear changes.

According to the teachings of the present invention there is further provided an electro mechanical bicycle derailleur actuator system connected to a bicycle having gearing and at least one derailleur, the derailleur having a cable, the system comprising: at least one derailleur actuator module (DAM) connectable to the bicycle and to the cable, the DAM comprising a rider to which the cable is attachable, the rider configurable onto a lead screw, the lead screw rotatable to displace the rider and the cable to effect gear changes, wherein the bicycle gearing is shiftable by the system.

### BRIEF DESCRIPTION OF THE DRAWINGS AND APPENDICES

The invention is herein described, by way of example only, with reference to the accompanying drawings, wherein:

FIG. 1 is a schematic side view of a prior art bicycle having a frame, and showing major typical components of the prior art bicycle;

FIG. 2 is a schematic side view of the prior art bicycle shown in FIG. 1 with an electro-mechanical actuator system installed thereupon, in accordance with an embodiment of the current invention.

FIG. 3 is a pictorial representation of a derailleur actuator module (DAM) installed on the bicycle stay, in accordance with an embodiment of the current invention;

FIGS. 4A-C are: a pictorial representation of the DAM of FIG. 3 without the cover, a side view of the DAM without the cover, and a pictorial representation of the mounting of the cable displacement unit (CDU) of FIG. 3, respectively, in accordance with an embodiment of the current invention;

FIG. 5 is a pictorial view of the cyclist interface module (CIM) of FIG. 2 installed on the handlebar, in accordance with an embodiment of the current invention;

FIG. 6 is a pictorial view of the control and power module (CPM) of FIG. 2 installed on the down tube, in accordance with an embodiment of the current invention; and

FIG. 7 is a flow chart showing the interaction of components of the electro-mechanical actuator system of FIG. 2, in accordance with an embodiment of the current invention.

### DETAILED DESCRIPTION OF THE PREFERRED EMBODIMENTS

The current invention relates to gearing and derailleur mechanism of a bicycle. More specifically, embodiments of the present invention are directed to electro mechanical derailleur actuation and methods thereof.

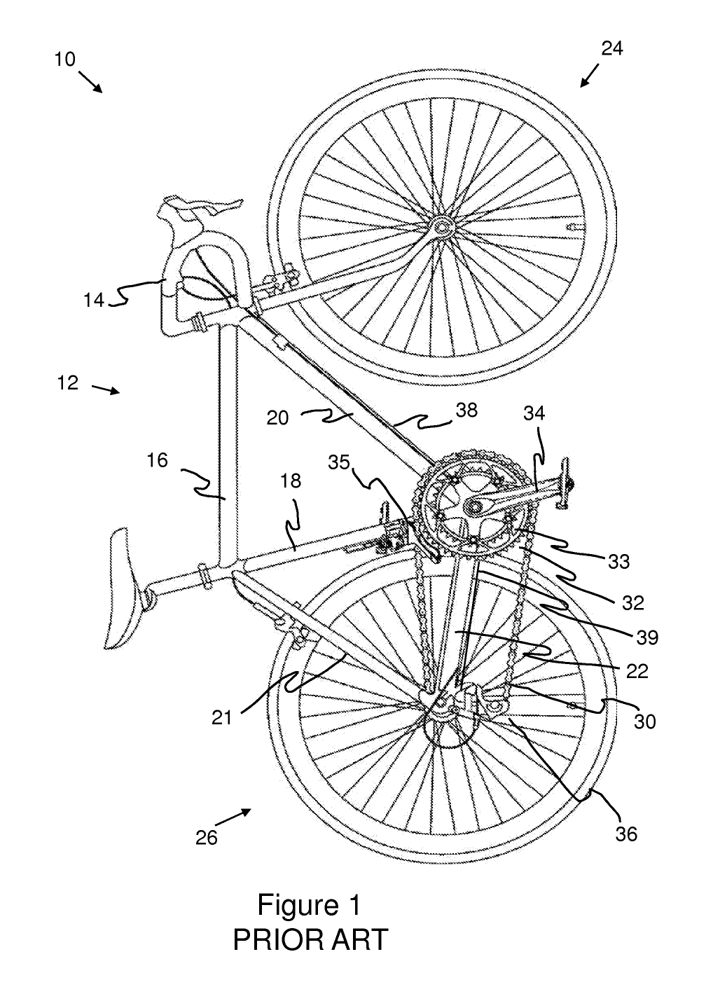

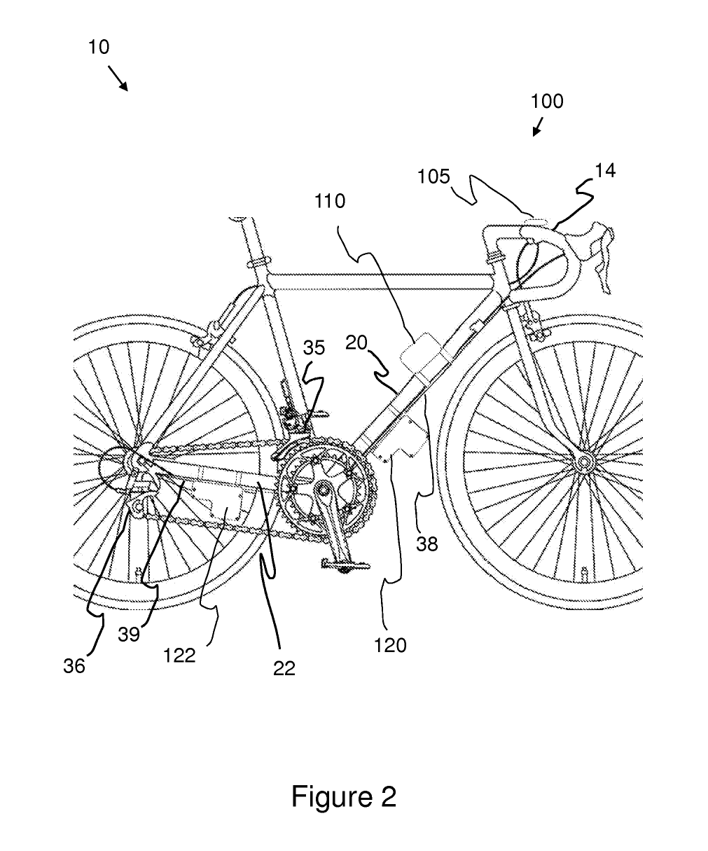

Reference is currently made to FIG. 2, which is a schematic side view of part of prior art bicycle 10 shown in FIG. 1, with an electro-mechanical actuator system 100 installed thereupon, in accordance with an embodiment of the current invention. Apart from differences described below, prior art bicycle 10 is identical in notation, configuration, and functionality to that shown in FIG. 1, and elements indicated by the same reference numerals and/or letters are generally identical in configuration, operation, and functionality as described hereinabove. Electro-mechanical actuator system 100 includes: a cyclist interface module (CIM) 105, a control and power module (CPM) 110, and derailleur actuator modules (DAM) 120 and 122. Cyclist interface module (CIM) 105 is shown in the figure mounted to handlebars 14, but may be alternatively or optionally mounted on down tube 20. Details of the CIM and its functionality are further discussed hereinbelow. Control and power module (CIM) 110, is typically mounted on down tube 20 and it has insulated power cables (not show in the figure) connecting it to derailleur actuator modules (DAM) 120 and 122. The DAM's are mounted on down tube 20 and chain stay 22, respectively, in the vicinity of front and rear derailleurs 34 and 36, respectively. Respective DAM's are mechanically attached to cables 38 and 39, as described hereinbelow. Alternatively or optionally, system 100 may employ only one DAM, however a more typical configuration is that of one DAM dedicated to one respective derailleur—yielding two DAM's for most bicycles employing two derailleurs.

The descriptions hereinbelow discuss one DAM (specifically DAM 122), however it is understood that the following description is applicable to two DAM's, mutatis mutandis.

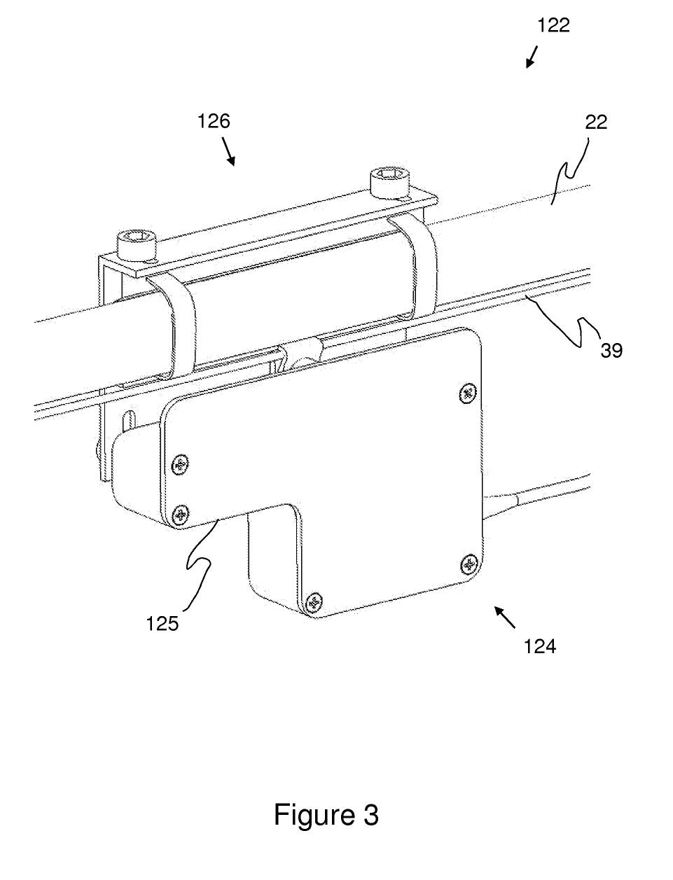

Reference is currently made to FIG. 3, which is a pictorial representation of DAM 122 of FIG. 2 installed on down tube 20 of bicycle 10, in accordance with an embodiment of the current invention. Apart from differences described below, DAM 122 is identical in notation, configuration, and functionality to that shown in FIG. 2, and elements indicated by the same reference numerals and/or letters are generally identical in configuration, operation, and functionality as described hereinabove. DAM 122 includes: a cable displacement unit (CDU) 124 with a cover 125 in position; and CDU mounting 126, which is mechanically secured to chain stay 22. The CDU is mechanically attached to mounting. Details regarding CDU mounting 126 and the CDU follow hereinbelow. As previously noted, DAM 122 is positioned on stay 22 to enable connection of the DAM to cable 39, as discussed hereinbelow. Although not shown in the figures, some bicycle configurations have cable 39 routed along seat stay 21 (instead of along chain stay 22 as shown in the figures). In such configurations, it would be appropriate to mount DAM 122 onto seat stay 21, and the following description would be modified, substituting seat stay 21 for chain stay 22, as appropriate.

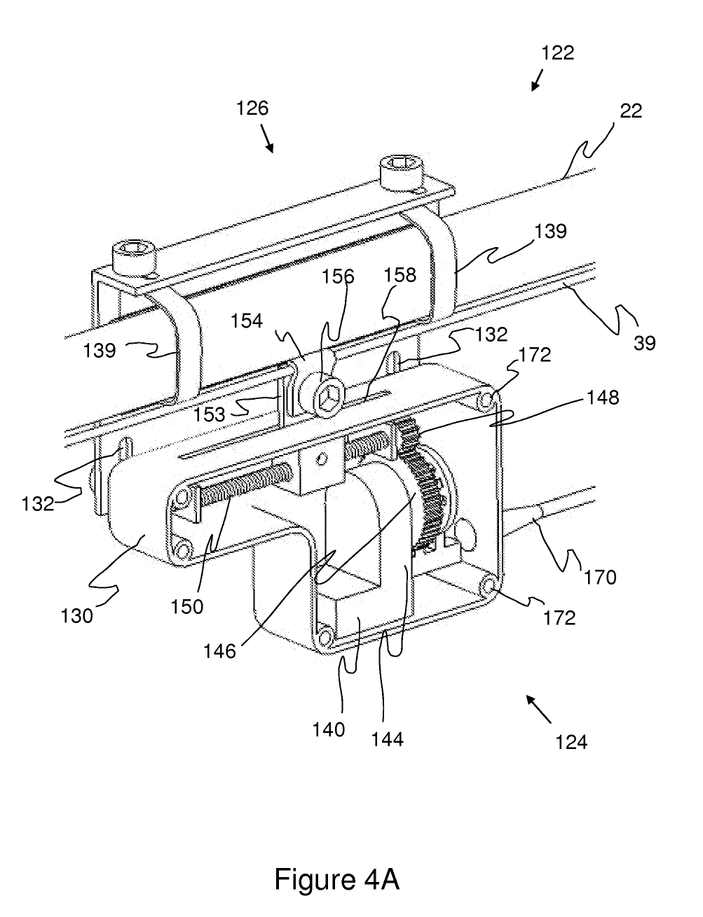

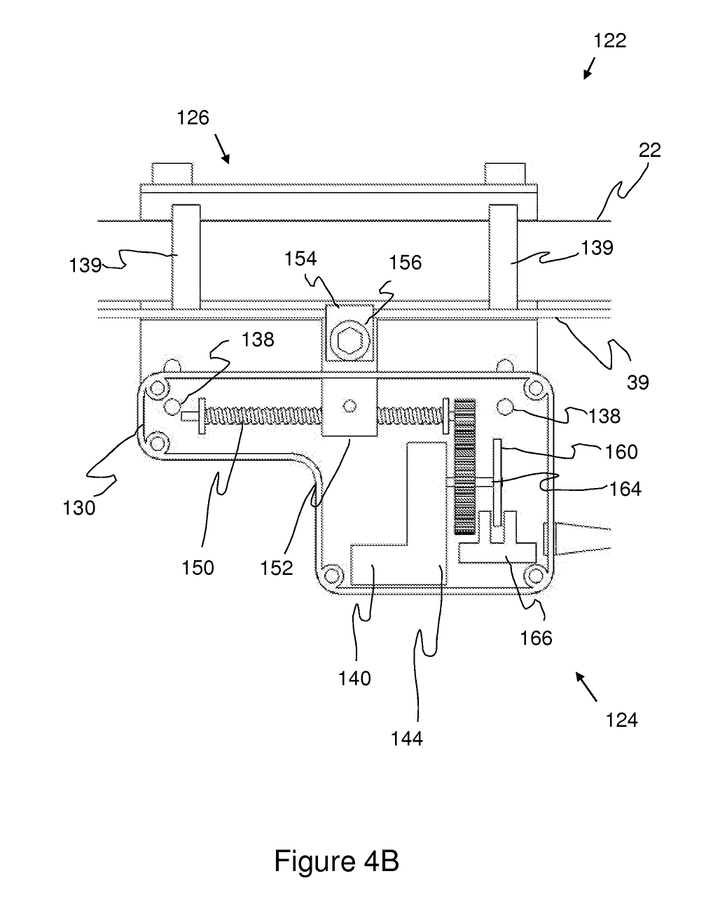

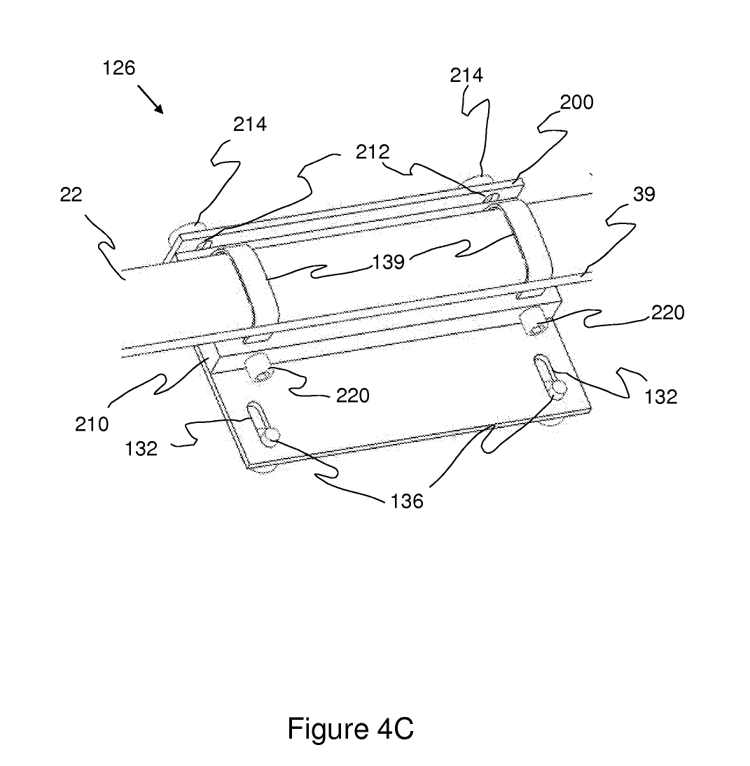

Reference is currently made to FIGS. 4A-C, which are a pictorial representation of DAM 122 of FIG. 3 without cover 125, a side view of the DAM without CDU cover 125, and a pictorial representation of CDU mounting 126 of FIG. 3, respectively, in accordance with an embodiment of the current invention. Apart from differences described below, DAM 122 is identical in notation, configuration, and functionality to that shown in FIG. 3, and elements indicated by the same reference numerals and/or letters are generally identical in configuration, operation, and functionality as described hereinabove.

In viewing FIGS. 4A-C, it can be seen that CDU 124 has a housing 130, which is mechanically attached to the CDU mounting 126 through two vertically-elongated slots 132 in the CDU mounting. Two threaded bolts 136 pass through slots 132 from behind the CDU mounting and connect into holes 138 in the base of housing 130 thereby securing the housing to the mounting. It can be seen that by way of the slots, the housing may be adjusted in an up-and-down direction before being fixed in place. Furthermore, since slots 132 are formed with a dimension somewhat larger than the diameter of bolts 136, a limited clockwise and/or counter-clockwise direction of adjustment is also afforded, before the housing is fixed in place by tightening the bolts. CDU mounting 126 is mechanically attached to chain stay 22 by two bands 139. Further details regarding the CDU mounting follow hereinbelow.

CDU 124 further includes an electric motor 140, which is attached to a gear box 144, which drives main gear 146. Main gear 146 drives pinion 148, which is mechanically attached to one end of lead screw 150, as shown. The other end of lead screw 150 is fixed in position, but may rotate freely. Rider 152 rides along lead screw 150, having a matched threading to that of the lead screw, as known in the art. As such, rider 152 moves from right to left and back, in response to motor 140 and resultant pinion 148 rotations. Rider 152 is formed to have an extended narrower surface 153. A clamp surface 154, which opposes narrower surface 153, has a screw 156, which passes through the clamp surface and is accepted into a threaded hole (not seen in the figure) in narrower surface 153. When cable 39 is positioned between clamp surface 154 and narrower surface 153 and when screw 156 is tightened, the two surfaces are biased together against the cable, serving to mechanically fix the rider to cable 39. In an embodiment of the current invention, screw 156 takes the form of a quick release screw, as know in the art, allowing the cable to be easily fixed and released, as necessary, without tools. It can be seen in FIG. 4A that extended narrower surface 153 passes through an elongated slot 158 in the upper surface of housing 130, the slot allowing the rider to move left and right, thereby displacing mechanically fixed cable 39 left and right.

Returning to housing 130, it can further be seen that rotary encoder 160 is attached to an axis common to main gear 146. Alternatively or optionally, rotary encoder may be positioned on the axis common to the main gear on the reverse side (not shown in the figure) of motor 140. Rotary encoder 160 and encoder sensor may include technologies known in the art, such as, but not limited to: optical, IR, and magnetic. Rotary encoder 160 is read by encoder sensor 166, as known in the art. Sensor information is fed back to the control and power module (CPM) 110 noted hereinabove in FIG. 2 (and which is further described hereinbelow) to provide feedback and control of the motor rotation and resultant rider and clamp displacement of cable 39. Cable harness 170 provides wiring (not shown in the figure) to the CDU from the CPM, the wiring which provides power and command and control signals to the motor. Cover 125 is held in position on housing 130 by threaded holes 172 in the housing, as known in the art.

Referring to FIG. 4C, CDU mounting 126 includes an L-shaped support bracket 200, in which slots 132 are formed (as described hereinabove) and in which two elongated slots 212 are formed in the shorter leg of the L-shape. A back plate 210 is secured to the support bracket by two threaded bolts 214. Back plate 210 is formed to have a shape generally matching that of stay 22 to allow a relatively snug fit of the back plate to stay 22 when bands 139 are tightened by tightening screws 220. It can be seen that elongated slots 212, allow support bracket 200 to be adjusted in the direction towards and away from stay 22 before the bracket is fixed in place. Furthermore, since slots 212 are formed with a dimension somewhat larger than the diameter of bolts 214, a limited clockwise and/or counter-clockwise direction of adjustment is also afforded, before the bracket is fixed in place by tightening the bolts. Bands 139 may be completely released, to remove the mounting or to aid in retrofit (as described hereinbelow) by loosening tightening screws 220.

Attaching DAM 122 to Bicycle 10—Retrofit Procedure

An embodiment of the current invention employs the following retrofit procedure to attach DAM 122 to stay 22, referring initially to FIG. 4C, followed by FIGS. 4A and 4B. It is again noted that while the following description refers to DAM 122 and to stay 22, it is can be understood that the following description is likewise applicable to DAM 120, stay 20, and cable 38, mutatis mutandis, as well as to attaching DAM 122 to seat stay 21.
1. Detach CDU mounting 126 completely from CDU 124 (ie. two threaded bolts 136 are loosened).
2. Loosen tightening screws 220 to release bands 139.
3. Position the CDU mounting behind stay 22 as shown in the figure and route bands 139 around the stay and between the stay and cable 39, reattaching the bands into back plate 210. (In this way, the bands will circumvent only the stay and not the stay along with the cable—which is incorrect.)
4. Tighten screws 220 to tighten the bands and ensure a snug fit of back plate 210 onto stay 22.
5. On CDU 124, loosen screw 156 to allow a space between clamp surface 154 and narrower surface 152.
6. Attach CDU 124 to CDU mounting 126 using two threaded bolts 136. Partially tighten threaded bolts 136 and 214 to allow CDU 124 to be adjusted, as below.
7. Position cable 39 in the space between clamp surface 154 and narrower surface 152. When the cable is in position, tighten screw 156 to fix cable 39 tightly between the two surfaces.
8. Adjust CDU 124 orientation to allow the clamp and narrower surfaces to move as collinearly as possible with cable 39. This can be done by moving the CDU with regard to the CDU mounting, taking advantage of slots 132 and 212 (and their associated threaded bolts, 136 and 214). Slots 132 allow the CDU to be moved substantially perpendicular to the cable, up and down and/or rotated somewhat in the plane substantially parallel to wheels 24 and 26. Slots 212 allow the CDU to be moved substantially perpendicular to the cable and parallel to the rear wheel axis, and/or rotated somewhat in the plane substantially parallel to the ground.
   After rechecking the movement of clamp and narrower surfaces 154 and 152 and cable 39 movement when the motor 140 is commanded to move the cable back and forth, make sure threaded bolts, 136 and 214 are tightened, thereby locking the position/orientation of the CDU in place.

If it is desired to remove DAM 122 from bicycle 10, follow the above steps in reverse.

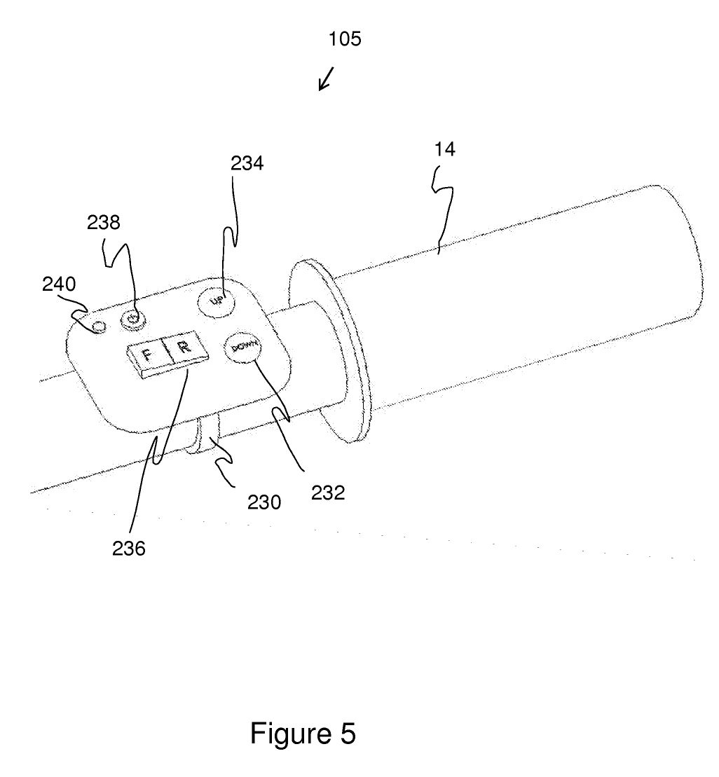

Reference is currently made to FIG. 5, which is a pictorial view of cyclist interface module (CIM) 130 installed on handlebar 14, in accordance with an embodiment of the current invention. Apart from differences described below, CIM 130 is identical in notation, configuration, and functionality to that shown in FIG. 2, and elements indicated by the same reference numerals and/or letters are generally identical in configuration, operation, and functionality as described hereinabove. Essentially, CIM 130 provides user interface with system 100. Elements of CIM 130 include: a connecting band 230; down and up control buttons 232 and 234, respectively; front and rear derailleur rocker selector switch 236; a power button 238; an operation indicator 240; and a communications and power module (not shown in the figure) to provide on board power and to enable communications to and from the CIM, as described hereinbelow. Connecting band 230 connects the CIM to the handlebars and may have a configuration similar to that shown hereinabove for bands 139 in FIGS. 4A-C. Down and up control buttons 232 and 234, respectively, are used to command the system to shift a gear up or down. If the respective control button is pushed twice in succession (ie “down”, “down”), the command is to shift two gears down, etc. Front and rear derailleur rocker selector switch 236 is used to indicate to the system on which derailleur (ie front or rear) to shift gears.

Power button 238 is used to activate and deactivate the system. When the system is deactivated, to use the bicycle in conventional, prior art gear shifting mode, clamp 154 is released (refer to FIGS. 4A-C) which releases cable 39, thereby allowing the conventional operation of the cable and the derailleur. Pressing the power button to activate the system and reattaching clamp 154 to cable 39 allows system operation of gear shifting, as described hereinabove.

An operation indicator 240 provides visual and/or audible feedback to indicate system operation. The CIM has on-board capability to transfer commands and receive feedback (ie “telemetry”) from control and power module (CPM) 110. A preferred mode of transferring commands and receiving feedback to/from CIM 130 is by wireless means, although wired means (not shown in the figure) may optionally or alternatively be employed. Additional description of CIM 130 and system operation follows hereinbelow.

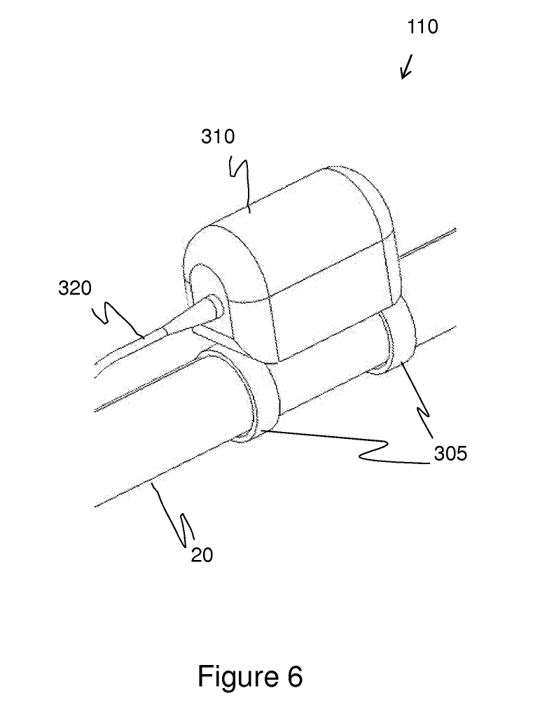

Reference is currently made to FIG. 6, which is a pictorial view of CPM 110 of FIG. 2, installed on down tube 20, in accordance with an embodiment of the current invention. Apart from differences described below, CPM 110 is identical in notation, configuration, and functionality to that shown in FIG. 2, and elements indicated by the same reference numerals and/or letters are generally identical in configuration, operation, and functionality as described hereinabove. While the following description refers to CPM 110 and to down tube 20, it is can be understood that the following description is likewise applicable to the CPM being installed on seat tube 18 and cross bar 16, mutatis mutandis. CPM 110 includes: connecting bands 305; a control and power module 310; and a control and power harness 320. Connecting bands 305 connect the CPM to down tube 20 and may have a configuration similar to that shown hereinabove for bands 139 in FIGS. 4A-C. Control and power module 310 includes communications and control electronics to allow CPM 110 to communicate with CIM 130 and with DAM's 120, 122 (as installed in the system) as further described hereinbelow, and a power source (not shown in the figure) to provide power for the CPM and the DAM's. The power source may be batteries, as known in the art. Control and power harness 320 connects with DAM's 120, 122 to provide both power and communications with the DAM's. Alternatively or optionally, communications with the DAM's may be by wireless means. Additional description of CPM 110 and how it interacts with components of system 100 and system operation follow hereinbelow.

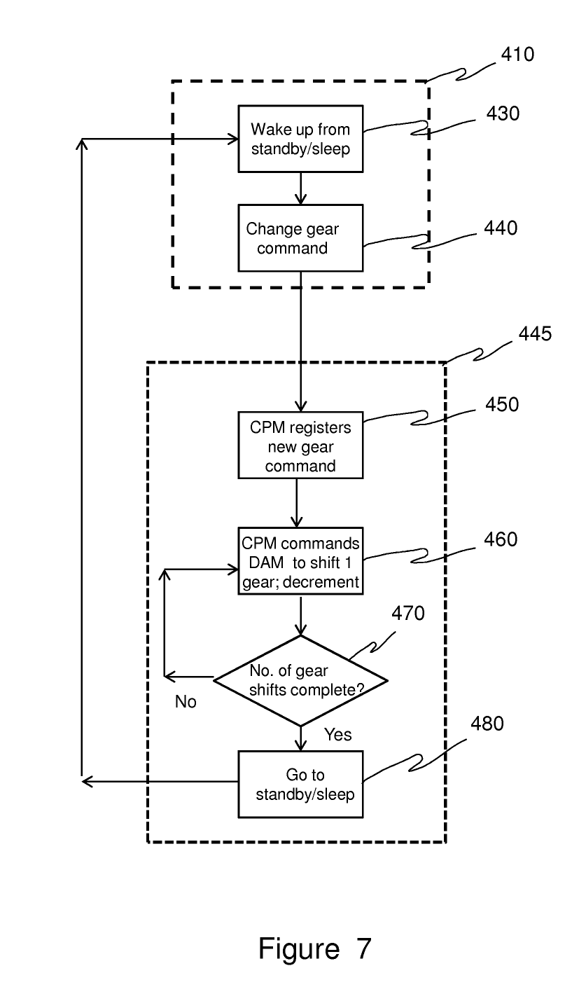

Reference is currently made to FIG. 7, which is a flow chart showing the interaction of components of electro-mechanical actuator system 100 of FIG. 2, in accordance with an embodiment of the current invention. Apart from differences described below, system 100 is identical in notation, configuration, and functionality to that shown in FIG. 2, and elements indicated by the same reference numerals and/or letters are generally identical in configuration, operation, and functionality as described hereinabove.

CIM commands 410 include: wake up from standby/sleep 430 and; change gear command 440. In step 430, when any of the buttons or switches of the CIM are touched by the cyclist the system “wakes up”, meaning it terminates a standby power-conserving mode (described hereinbelow) and begins to operate in a normal power mode. In step 440, a forward/rear derailleur is chosen and the command of shifting up or down is entered. One or more commands to shift may be entered.

Control is currently transferred to the CPM and the DAM. CPM and DAM processing 445 includes: CPM registers new gear command 450; CPM commands DAM to shift one gear and decrement 460; check if the number of gear shifts is complete 470; and go to standby/sleep mode. Once one or more gear change commands have been given from the CIM in step 440, the CPM erases previous gear commands and registers the near gear command/commands in step 450. An exemplary gear command could be: front derailleur, shift up, twice (the “up” bottom of the CIM was pushed twice). A counter is initiated with the total number of gear shifts. In the specific example used herein, the counter initial value would be 2.

In step 460, the CPM then commands the DAM to shift one gear. The DAM proceeds to perform one gear shift. Shifting of a gear is verified by the DAM by sensors in the CDU (sensing cable tension and/or CDU motor/encoder status) and alternatively or optionally by sensors which may be located on a respective derailleur to feed back gear status. Gear shift status is transferred to the CPM from the DAM. The CPM then decrements the gear shift counter by one, in step 460.

In step 470, the counter is checked to see if its value is not zero. A non-zero value indicates that not all of the gear shifts are complete and control is shifted to step 460, for another gear shift. If the counter value is presently zero, indicative of completion of gear shifts, control is passed to step 480. In step 480, a timer is started and the system is then set to a power savings standby/sleep mode after a predetermined time without subsequent commands and control is returned back to step 430, for the next cycle of gear shift commands from the CIM. The predetermined time may typically be 10 seconds, but a longer or shorter time interval may be programmed into the system.

It will be appreciated that the above descriptions are intended only to serve as examples, and that many other embodiments are possible within the scope of the present invention as defined in the appended claims.

1. An electro mechanical bicycle derailleur actuator system, retrofittable to a bicycle having gearing and at least one derailleur, the derailleur having a cable, the system comprising:
at least one derailleur actuator module (DAM) connectable to the bicycle and to the cable;
a cyclist interface module (CIM) connectable to the bicycle for cyclist interface with the system; and
a control and power module (CPM) connectable to the bicycle serving to control and power the system,
wherein the bicycle gearing is shiftable by the system without derailleur cable modification.

2. The system of claim 1, wherein derailleur cable modification includes one chosen from the list including: cutting; shortening; rerouting; lengthening, removing; and replacing of the cable.

3. The system of claim 2, wherein the at least one DAM further comprises: a mounting connectable to a stay of the bicycle and having positional adjustment in two degrees of freedom and a cable displacement unit (CDU) connectable to the mounting and the cable, the CDU having positional adjustment in a third degree of freedom.

4. The system of claim 3, wherein the CDU includes a motor having an axis, the motor adapted to drive a lead screw on which a rider is configured and wherein the rider is attachable to the cable, the rider adaptable to displace the cable to effect gear changes.

5. The system of claim 4, wherein the CDU further includes an encoder attachable to the axis, the encoder adapted to provide feedback regarding cable displacement by the rider.

6. The system of claim 5, wherein the CDU additionally includes means to: receive commands from the CPM; transfer information regarding cable displacement to the CPM; and receive power from the CPM.

7. The system of claim 1, wherein the CIM includes on board power and a means to transfer commands to the CPM including one chosen from the list including: wireless and wired.

8. The system of claim 1, wherein the CPM includes on-board power and wiring to transfer the power to the CDU and means to transfer commands to and receive information from the CDU.

9. The system of claim 8, wherein means to transfer commands and receive information to and receive information from the CDU includes one chosen from list including: wireless and wired.

10. The system of claim 1, wherein system is commandable to allow bicycle gear shifting not by the system.

11. A method of retrofitting an electro mechanical bicycle derailleur actuator system to a bicycle having gearing and at least one derailleur the derailleur having a cable, the method comprising the steps of:
connecting at least one derailleur actuator module (DAM) to the bicycle and to the cable;
connecting a cyclist interface module (CIM) to the bicycle for cyclist interface with the system; and
connecting a power module (CPM) to the bicycle serving to control and power the system,
wherein the bicycle gearing is shifted by the system without derailleur cable modification.

12. The method of claim 11, wherein derailleur cable modification includes one chosen from the list including: cutting; shortening; rerouting; lengthening, removing; and replacing of the cable.

13. The method of claim 12, wherein the at least one DAM further comprises: a mounting connected to a stay of the bicycle and having positional adjustment in two degrees of freedom and a cable displacement unit (CDU) connected to the mounting and the cable, the CDU having positional adjustment in a third degree of freedom.

14. The method of claim 13, wherein the CDU includes a motor having an axis, the motor driving a lead screw on which a rider is configured and wherein the rider is attached to the cable, the rider displacing the cable to effect gear changes.

15. An electro mechanical bicycle derailleur actuator system connected to a bicycle having gearing and at least one derailleur, the derailleur having a cable, the system comprising:
at least one derailleur actuator module (DAM) connectable to the bicycle and to the cable, the DAM comprising a rider to which the cable is attachable, the rider configurable onto a lead screw, the lead screw rotatable to displace the rider and the cable to effect gear changes,
wherein the bicycle gearing is shiftable by the system.
